(19) United States
(12) Patent Application Publication
(10) Pub. No.: US 2009/0146033 A1
(43) Pub. Date: Jun. 11, 2009

(54) Screen supporting rack

(76) Inventor: Sin Yi Chiang, Taipei County (TW)

Correspondence Address: BACON & THOMAS, PLLC, 625 SLATERS LANE, FOURTH FLOOR, ALEXANDRIA, VA, 22314-1176, US

(21) Appl. No.: 12/000,113

(22) Filed: Dec. 10, 2007

(51) Int. Cl. A47B 96/06; F16C 11/04; G09F 7/18; G06F 1/16

(52) U.S. Cl. 248/284.1; 403/161; 248/229.15

(57) ABSTRACT

A screen supporting rack comprising a fixing seat for fixing the whole screen supporting rack on a desk or a wall, at least a cantilever pivotally provided on the fixing seat to make relative rotation, and a connecting seat for pivotally connecting the cantilever and fixing on a back plate of a screen, so that the screen can be angularly adjusted by rotating of the cantilever. Wherein the cantilever further has a first branch arm and a second branch arm respectively on one and the other end of it, a positioning frame connects between the first branch arm and the second branch arm, the positioning frame has a positioning portion to fix at least a decoration panel, a user thus can change for any of various patterns and figures according to his own fondness. And quality of the supporting rack can be elevated.

### BACKGROUND OF THE INVENTION

1. Field of the invention

The present invention relates to a screen supporting rack, and especially relates to a supporting rack for supporting a thin style screen; the supporting rack can be pivotally rotated.

2. Description of the Prior Art

In the recent years, thin style screens such as those for liquid crystal displays (LCD) for desk-top computers, liquid crystal displays (LCD) for household TVs, (PDP) plasma TVs etc. have gradually take the place of conventional cathode ray tube (CRT) screens and become essential standard equipment in families, offices and even in those public places such as traffic stations and meeting rooms because of their advantages of beautiful appearances, saving spaces and low radiation.

As mentioned above, because of the advantages of beautiful appearances, saving spaces and low radiation, the thin style screens can be less influenced by environmental factors in mounting, a user can take the advantage of such screen supporting racks to install thin style screens on desks or walls according to ones own fondness; additionally, another function of the screen supporting racks is that the screens can be adjusted in their angles of left, right turning as well as elevation angles, so that the positions of the thin style screens in mounting can have more options.

Screen supporting racks adjustable in their angles of left, right turning as well as elevation angles sold in the markets are divided generally into two kinds, i.e., the desk-top type and the hung-on wall type. Each of the basic structures of them is: a fixing seat for fixing a screen supporting rack on a desk or a wall, at least a cantilever pivotally provided on the fixing seat for making relative rotation, and a connecting seat pivotally provided on the cantilever and fixed on a back plate of a screen.

When the above mentioned screen supporting rack is rotated for left or right turning, by the fact that the cantilever is not certainly obscured by the thin style screen and thus is exposed, a conventional cantilever had not been designed to solve such a situation, thereby the conventional screen supporting rack looks dull and is hard to get attention of people.

In view of this, the gist of the present invention is to design a screen supporting rack having a cantilever which is personalized, able to change its appearance in pursuance of the fondness of a user, and even able to increase the value of commodity.

### SUMMARY OF THE INVENTION

The primary object of the present invention is to provide a screen supporting rack, in which at least a cantilever is pivotally provided to connect a fixing seat and a connecting seat. The screen supporting rack comprises:

at least a cantilever which is provided further with a first branch arm, a second branch arm and a positioning frame connecting between the first branch arm and the second branch arm, wherein the tailing ends of the first branch arm and the second branch arm are provided each with a pivot portion, the positioning frame has a positioning portion to fix at least a decoration panel;

the fixing seat for fixing the whole screen supporting rack, the fixing seat has a first pivot end to pivotally connect the pivot portion of the first branch arm; and

the connecting seat for fixing on a back plate of a screen, the connecting seat has a second pivot end to pivotally connect the pivot portion of the second branch arm.

The positioning portion is connected with the positioning frame by means of ribs on the periphery thereof, the positioning portion is connected with a plurality of decoration panels to fix the decoration panels.

And more, the bottom of the fixing seat has a clip for clamping on a desk, or has a sheet for fixing on a wall by means of screws.

When in practicing, two decoration panels are used and form a pair of mutually opposite semi-circular arc shapes, the two decoration panels are combined with the two sides of the positioning frame respectively to form a ball shape, the surfaces of the two decoration panels can be processed to get various patterns and figures, such as the figures of base balls, socker balls, golf balls and foot balls etc.

In comparison with the prior art, the present invention can allow agile angular adjustment, it is decorative and can change its appearance in pursuance of the fondness of a user, and even is able to increase its value of commodity; all these are effects that the prior art has never owned.

The present invention will be apparent after reading the detailed description of practice of the technical means of the preferred embodiment in reference to the accompanying drawings.

### BRIEF DESCRIPTION OF THE DRAWINGS

FIG. 1 is an anatomic perspective view of a first embodiment of the present invention;

FIG. 2 is a schematic perspective view showing connecting a cantilever with decoration panels of the first embodiment of the present invention;

FIG. 3 is a perspective view like that of FIG. 1 of the present invention after assembling;

FIG. 4 is a perspective view of a second embodiment of the present invention;

FIG. 5 is a perspective view of a third embodiment of the present invention.

### DETAILED DESCRIPTION OF THE PREFERRED EMBODIMENT

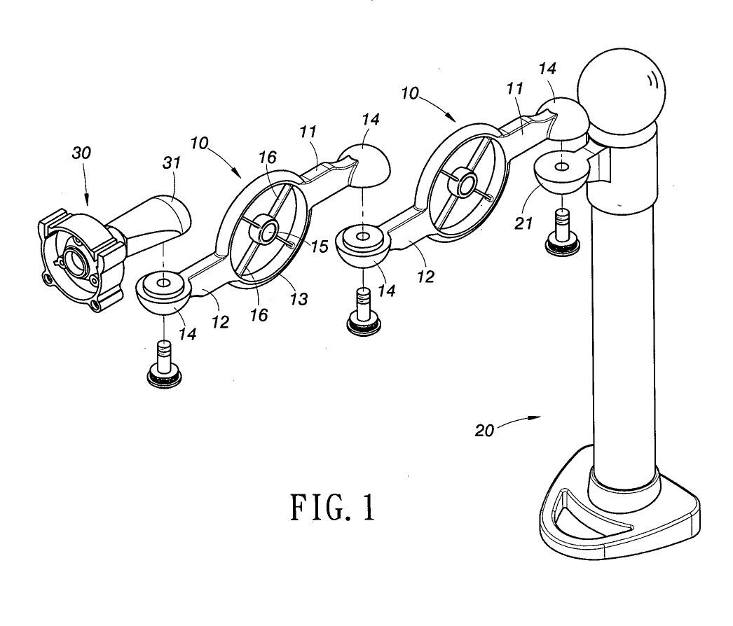

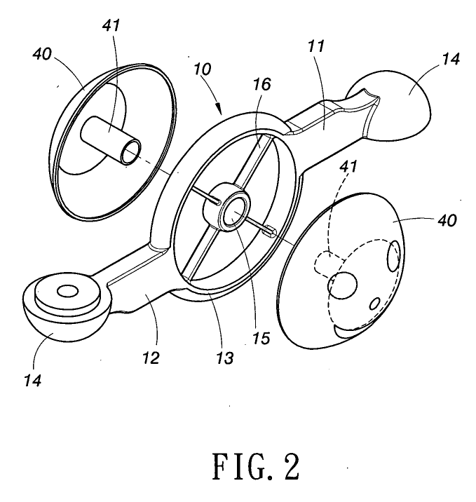

As shown in FIGS. 1 and 2 showing perspective views of a first embodiment of the present invention, in which it is disclosed that the screen supporting rack of the present invention comprises: at least a cantilever 10, a fixing seat 20 and a connecting seat 30, wherein:

The cantilever 10 is provided further with a first branch arm 11, a second branch arm 12 and a positioning frame 13 connecting between the first branch arm 11 and the second branch arm 12, in which the tailing ends of the first branch arm 11 and the second branch arm 12 are provided each with a pivot portion 14, the positioning frame 13 has a positioning portion 15 to fix at least two decoration panels 40.

The fixing seat 20 is used for fixing the whole screen supporting rack on a desk or a wall, the fixing seat 20 depicted has a cylindrical portion and has a pivot end 21 to pivotally connect with the pivot portion 14 on the first branch arm 11 of the cantilever 10, so that the cantilever 10 can rotate relatively to the fixing seat 20 taking the pivot portion 14 on the first branch arm 11 as an rotating axle.

The connecting seat 30 is used for fixing a back plate of a screen, it has a second pivot portion 31 in order to be connected to the pivot portion 14 on the second branch arm 12, so that the cantilever 10 can rotate relative to the fixing seat 20 taking the pivot portion 14 on the second branch arm 12 as an rotating axle.

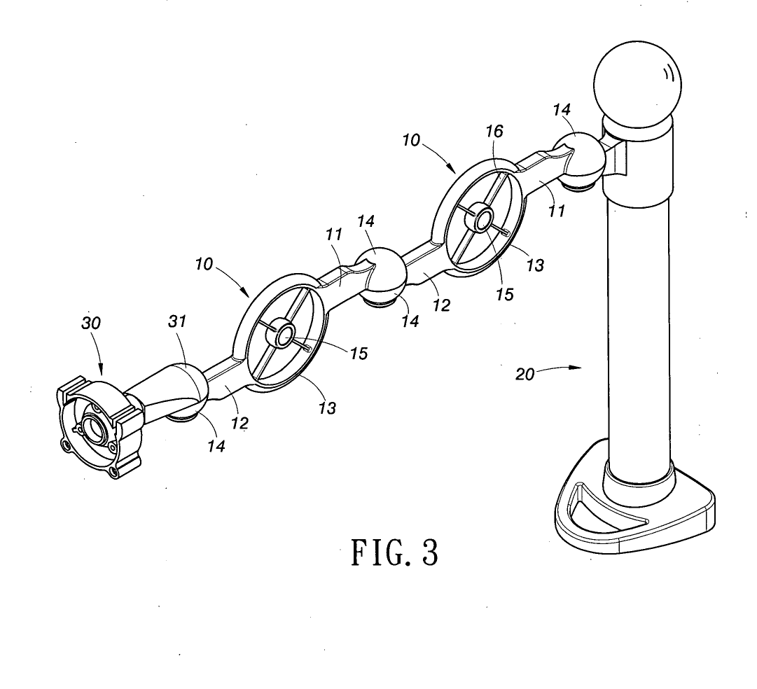

As shown in FIG. 3, two cantilevers 10 are used in this embodiment to be pivotally connected with each other, the second branch arm 12 of one of the cantilevers 10 is pivotally connected with the connecting seat 30, the first branch arm 11 on the other end of the cantilever 10 is pivotally connected with the second branch arm 12 of the second cantilever 10, while the first branch arm 11 on the second cantilever 10 is pivotally connected with the fixing seat 20; in this way, not only the whole screen supporting rack can have its rotating angle adjusted, but also distance can be adjusted by changing the intersection angle between the two cantilevers 10.

When in practicing, the positioning frames 13 and the positioning portions 15 of the two cantilevers 10 are all annular; for either of the two cantilevers 10, the inner diameter of its positioning frame 13 is larger than and encircles the outer diameter of its positioning portion 15, the inner periphery of the positioning frame 13 is connected by means of a plurality of inwardly extending ribs 16 with the outer diameter of the positioning portion 15; the ribs 16 depicted in the drawing are four in number forming hubs to firmly connect the positioning portion 15 with the positioning frame 13.

Again referring to FIG. 2 which is a schematic perspective view showing connecting of a cantilever 10 with two decoration panels 40, we can see in the drawing that the two decoration panels 40 used form a pair of mutually opposite semi-circular arc shapes, each has a central fixing member 41 extending inwardly, the fixing members 41 can be connected with each other to connect the two decoration panels 40; in practicing, the positioning portion 15 is generally annular, thereby the central fixing members 41 of the two decoration panels 40 can be cylindrical, the fixing members 41 can be connected with each other after extending into the annular positioning portion 15 and connected with the positioning frame 13 at two lateral sides respectively of the latter, thereby the two semi-circular decoration panels 40 form a ball shape.

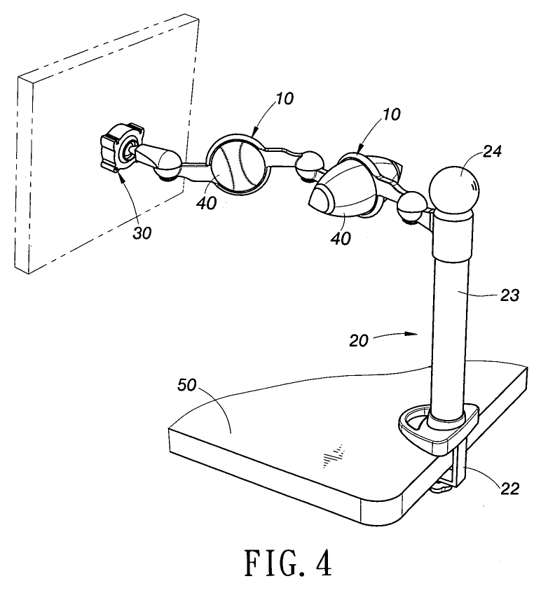

As shown in FIG. 4 which shows a perspective view of a second embodiment of the present invention, in the drawing, the above mentioned fixing seat 20 fixes the whole screen supporting rack on a desk 50. When in practicing, the fixing seat 20 is provided further on its bottom with a generally “L” shaped clip 22 for clamping on an edge of the desk 50. And more, the fixing seat 20 is provided with a supporting post 23, the above mentioned pivot end 21 is mounted on the a supporting post 23, the top of the supporting post 23 can be provided with a light emitting member 24 that is connected to a power source, so that the screen supporting rack can have a function of illumination.

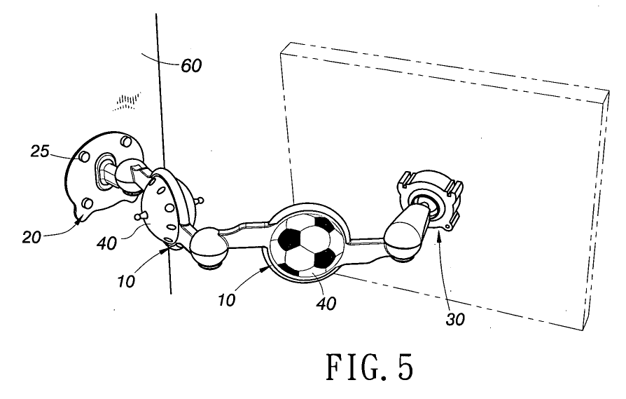

FIG. 5 shows a third embodiment of the present invention, in the drawing, the above mentioned fixing seat 20 fixes the whole screen supporting rack on a wall 60. When in practicing, the fixing seat 20 is a sheet member, so that the screen supporting rack can be fixed on the wall 60 by means of screws 25.

Moreover, as shown in FIGS. 4 and 5, the above mentioned decoration panels 40 can be processed to get various patterns and figures, and can be formed base balls, socker balls, golf balls and foot balls etc. in matching with the shape of the semi-circular arc shaped decoration panels 40; mutually opposite decoration panels 40 can even be formed the shapes of irregular circles, consumers can change the decoration panels 40 according to their own fondness, so that the screen supporting rack can be variant in shape.

The embodiment described and depicted in the drawings is only for illustrating the present invention, and not for giving any limitation to the scope of the present invention. Therefore various equivalent modifications or changes in structure, assembling and features without departing from the object and spirit of this invention shall also fall within the scope of the appended claims.

1. A screen supporting rack comprising:
at least a cantilever which is provided further with a first branch arm, a second branch arm and a positioning frame connecting between said first branch arm and said second branch arm, wherein tailing ends of said first branch arm and said second branch arm are provided each with a pivot portion, said positioning frame has a positioning portion to fix at least a decoration panel;
a fixing seat for fixing said screen supporting rack, said fixing seat has a first pivot end to pivotally connect said pivot portion of said first branch arm; and
a connecting seat for fixing a back plate of a screen, said connecting seat has a second pivot end to pivotally connect said pivot portion of said second branch arm.

2. The screen supporting rack as claimed in claim 1, wherein said screen supporting rack has two cantilevers to be pivotally connected with each other, said second branch arm of one of said cantilevers is pivotally connected with said connecting seat, said first branch arm on other end of said cantilever is pivotally connected with said second branch arm of said second cantilever, while said first branch arm on second one of said cantilevers is pivotally connected with said fixing seat.

3. The screen supporting rack as claimed in claim 1, wherein said positioning frame and said positioning portion of said at least a cantilever are both annular; an inner diameter of said positioning frame is larger than and encircles an outer diameter of said positioning portion, an inner periphery of said positioning frame is connected by means of a plurality of inwardly extending ribs with said outer diameter of said positioning portion.

4. The screen supporting rack as claimed in claim 3, wherein said screen supporting rack has two decoration panels forming a pair of mutually opposite semi-circular arc shapes, each of said two decoration panels has a central cylindrical fixing member extending inwardly, said two fixing members are adapted to connecting with each other after extending into said annular positioning portion and connected with said positioning frame at two lateral sides of said positioning frame respectively, thereby said two semi-circular decoration panels form a ball shape.

5. The screen supporting rack as claimed in claim 1, wherein said fixing seat is provided further on its bottom with a generally “L” shaped clip for clamping on an edge of a desk.

6. The screen supporting rack as claimed in claim 1, wherein said fixing seat is a sheet member in order to be adapted to fixing on a wall by means of screws to fix said screen supporting rack on said wall.

7. The screen supporting rack as claimed in claim 1, wherein said fixing seat is provided with a supporting post, said pivot end is mounted on said supporting post, a top of said supporting post is provided with a light emitting member that is connected to a power source.
